(19) United States
(12) Patent Application Publication
(10) Pub. No.: US 2026/0131937 A1
(43) Pub. Date: May 14, 2026

(54) WATERPROOF PAPER-BASED PALLET AND METHOD OF PRODUCING SUCH A PALLET

(71) Applicants: Zoltán ÁCS, Budapest (HU); Anna Mária VASS, Budapest (HU); Péter MÁTÉ, Pécs (HU)

(72) Inventors: Zoltán ÁCS, Budapest (HU); Anna Mária VASS, Budapest (HU); Péter MÁTÉ, Pécs (HU)

(21) Appl. No.: 19/118,283

(22) PCT Filed: Oct. 12, 2023
(86) PCT No.: PCT/HU2023/050071

§ 371 Date: Apr. 3, 2025

(30) Foreign Application Priority Data
Oct. 13, 2022 (WO) PCT/HU2022/050073

(51) Int. Cl. B65D 19/00; B32B 3/26; B32B 5/02; B32B 29/02; B32B 29/08

(52) U.S. Cl. CPC B65D 19/0048; B32B 3/266; B32B 5/028; B32B 29/02; B32B 29/08; B32B 2255/02; B32B 2255/26; B32B 2307/7265; B32B 2307/7376; B32B 2553/00; B65D 2519/00019; B65D 2519/00034; B65D 2519/00044; B65D 2519/00054; B65D 2519/00273; B65D 2519/00288; B65D 2519/00333

(57) ABSTRACT

The present invention relates to a waterproof paper-based pallet having a paper pallet body, the paper pallet body comprising a paper panel having a load-bearing upper side and paper legs connected to the paper panel. The essence of the invention is that the paper pallet body has a spray-formed coating of a solvent-free polyurethane system, a polyurea system or a hybrid polyurea system around its entire outer surface. The invention also relates to a method of producing such a paper-based pallet.

Present invention relates to a waterproof paper-based pallet having a paper pallet body, the paper pallet body comprising a paper panel having a load bearing upper side and paper legs connected to the paper panel.

The present invention also relates to a method of producing a paper-based pallet.

Nowadays, paper pallets are becoming increasingly popular due to their cheap and easy production. A growing number of manufacturers now use paper pallet production technology, which offers the advantages of automation, dimensional accuracy and the possibility of using recycled paper as a raw material, and the resulting pallets are cheap, lightweight and recyclable. However, paper pallets also have obvious disadvantages, such as:
sensitivity to water and moisture,
vulnerability,
limited lifetime for the above reasons,
limitations in load-bearing capacity,
flammability.

Attempts are being made to address these shortcomings, but with limited results.

For example, a common way to improve water resistance/humidity tolerance is to apply thin coatings, varnishes, paints, waxes. However, these solutions are of limited use in eliminating water and moisture susceptibility. The main problem is the fragility of the surface, which occurs very easily during use, and once damaged, it no longer provides protection against water and moisture.

An example of the use of waterproof paint can be seen in patent application CN100547157C.

Another common solution is to use shrink film. This provides a somewhat higher level of mechanical protection against damage, but it still does not meet the requirements of warehousing and transport, and is not suitable for complete surface protection, i.e. it does not protect the pallet, for example, against moisture from below, high humidity, or condensation caused by temperature differences. In the case of paper pallets, this will result in an immediate and measurable deterioration in quality/performance, in most cases rendering the pallet unusable.

To protect against mechanical damage and to improve load capacity, many manufacturers try to reinforce the pallet's loading surface, for example by adding an extra layer of paper. The use of thicker and more dense leg distribution also serves to increase the load capacity. However, these methods increase the size and weight of the pallet while not significantly improving mechanical resistance and load capacity.

Hungarian patent application No HU1700062A2 discloses a paper pallet that owes its particular load-bearing capacity under bending loads to transversely arranged cross-stiffening profile elements on the pallet base elements, which are hollow closed profile elements folded from cardboard. The load-bearing capacity of the paper pallet is improved by the use of profiled elements in its structure, preferably designed with a roll-up arrangement, whose structural stability increases with the number of roll-up slab elements. However, the resulting paper pallets still only have a load capacity of around 800-1,500 kg, which is usually not sufficient for construction applications.

The problem of flammability is not or only slightly addressed by the methods described above. Paper pallets are inherently flammable, and chemical processes are used to reduce this flammability, if necessary, but this does not help to overcome the other mentioned disadvantages, and the paper pallet loses its environmentally friendly character and, with a good chance, recyclability.

The aim of the invention is to provide a paper-based pallet that is free from the disadvantages of prior art solutions. The purpose of the invention is to provide a solution that is able to eliminate the above disadvantages (water and moisture sensitivity, mechanical fragility, low load capacity, flammability) while preserving the advantages of conventional paper pallets (low-cost production, low weight, recyclability).

The invention is based on the recognition that by coating a conventional paper pallet body with a few mm thick coating of a sprayable PU system, the resulting paper-based pallet not only has improved water resistance and reduced flammability, but also has a significantly, typically by at least 35-220% increased static and dynamic load capacity.

Based on the above recognition, the problem is solved by a waterproof paper pallet having a paper pallet body, the paper pallet body comprising a paper panel having a load bearing upper side and paper legs attached thereto. The invention is characterized in that the paper pallet body has a coating of a synthetic polymer system around its entire outer surface, the synthetic polymer system being selected from the group consisting of a polyurethane system, a polyurea system and a hybrid polyurea system. The coating material is thus solvent-free polyurethane system and/or polyurea system and/or hybrid polyurea system. These systems are hereinafter collectively referred to as PU systems, where PU may refer to solvent-free polyurethane, polyurea and hybrid polyurea. Since the polyurea system and the hybrid polyurea system are also solvent-free, the PU systems forming the coating according to the invention are solvent-free PU systems. The coating is created by spraying, which can be carried out with a high pressure, heated spraying apparatus capable of spraying a sprayable PU system. Thus, in the context of the present invention, a sprayable PU system is understood to be a sprayable solvent-free PU system that can be used as a coating, but is not a foam.

The PU coating is preferably 1-8 mm thick, preferably 1-5 mm thick, for example 1-3 mm thick or 3-5 mm thick.

The invention also relates to a method of producing a waterproof paper-based pallet according to the invention, wherein a PU coating of preferably 1-8 mm thickness, more preferably 1-5 mm thickness is produced from a sprayable PU system on the entire outer surface of the paper pallet body using a spraying machine.

The inventors also recognised that the increase in load capacity is even more significant if the more stressed parts of the paper sheet body (e.g. load bearing upper side, legs, curved edges, glued joints) are reinforced with fibrous reinforcing material and the coating of the sprayable PU system is formed together therewith, thus embedding the reinforcing material in the coating.

According to the above recognition, in a particularly preferred embodiment of the invention, a fibrous reinforcing layer is arranged at least partially on the upper side of the paper panel and/or legs and/or curved edges and/or glued joints of the paper pallet body, and the fibrous reinforcing layer is also coated with the PU coating.

The fibrous reinforcement material is preferably selected from architectural facade mesh, plastic mesh, glass mesh, glass fabric, glass fibre, metallic wool, steel cord, carbon fibre reinforcing material, carbon fibre, hemp fibre, and cut-glass fibre reinforcing material.

An alternative way of using fibrous reinforcing material is to mix the fibrous reinforcing material into the sprayable PU system. This can be technically achieved by mixing a fibrous reinforcing material into the spray flow of the sprayable PU system during the spraying process.

It was further recognised that in order to ensure proper waterproofing of hollow layered paper materials where there is a gap between the layers (e.g. wherein corrugated paper separates flat paper layers such as in case of single-layer or multilayer cardboard paper), it is necessary to seal the cut edges of the paper pallet body facing outwards (i.e. providing the outer surface), otherwise the sprayed PU system will be spread into the gap at the cut edge and will not form a solid waterproofing surface. Based on this recognition, if the material of the paper pallet body is preferably a multi-layered cardboard with hollow structure, the cut edges forming the outer surface of the paper pallet body are covered with an edge covering element, and the covering element is also coated with the PU coating. It is particularly preferred if the covering element is a layer comprising a fibrous reinforcing material having perforations of up to 5 mm in diameter. If the paper pallet body is made of a pressed paper sheet, which is not hollow, then the cut edges forming the outer surface do not need to be covered for the waterproofing of the PU coating, but it may be advantageous to increase the load capacity. In addition, pressed paper sheets may have deeper grooves that are also advantageous to cover with a covering element and to spray the PU coating on top of the covering element.

Since the setting time of the PU systems that can be used as a coating according to the invention is extremely short (less than 60 sec, typically 10-30 sec), the PU system is sprayed at high pressure, preferably at 140-250 Bar, typically 160-210 Bar, with a heated spraying apparatus. With such spraying apparatus, spraying is typically carried out at a temperature of 40-90° C., preferably 60-80° C.

Further details of the invention will be described with reference to the accompanying drawings. In the drawing is

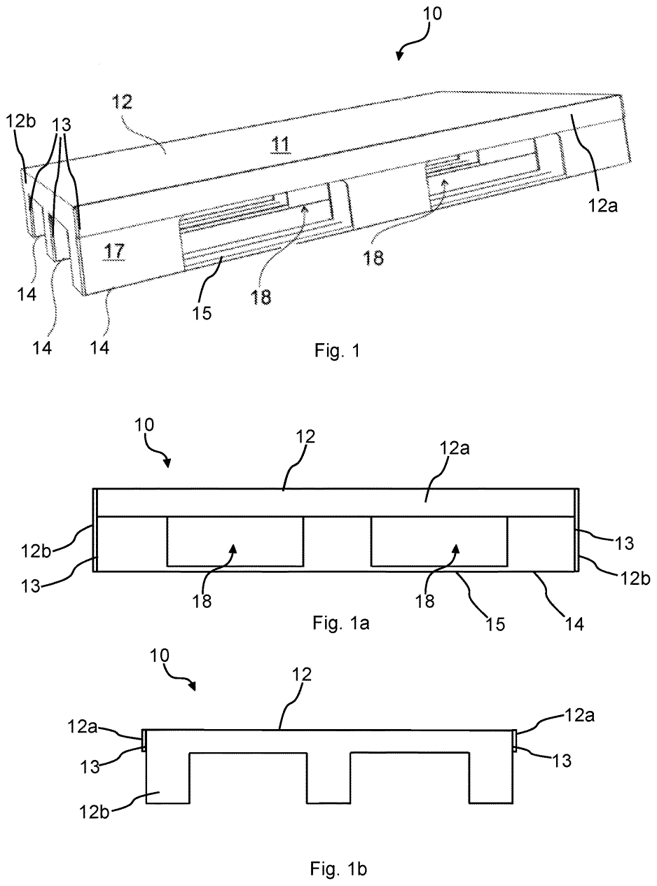

FIG. 1 is a perspective top view of an exemplary, state-of-the-art paper pallet;

FIG. 1a is a schematic side view of the longer side of the body of the paper pallet according to FIG. 1;

FIG. 1b is a schematic side view of the shorter side of the body of the paper pallet according to FIG. 1;

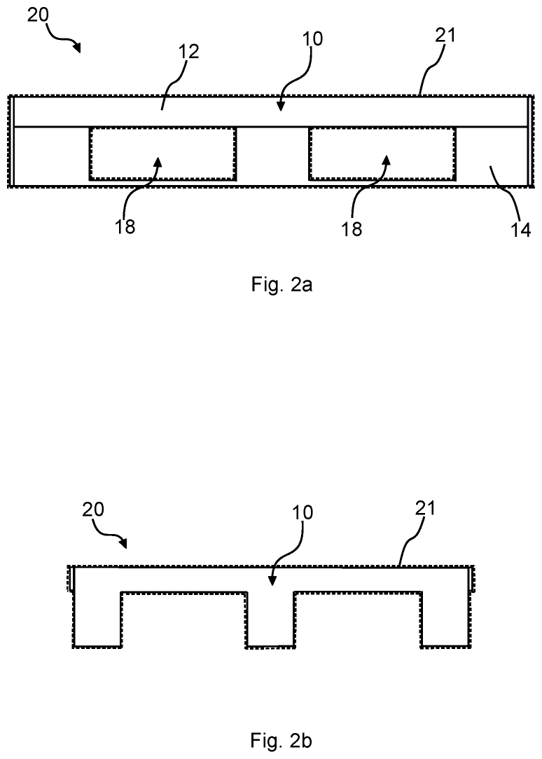

FIG. 2a schematically illustrates the location of the sprayed PU coating according to the invention around the outer surface of the paper pallet body in the view of FIG. 1a;

FIG. 2b schematically illustrates the location of the sprayed PU coating according to the invention around the outer surface of the paper pallet body in the view of FIG. 1b;

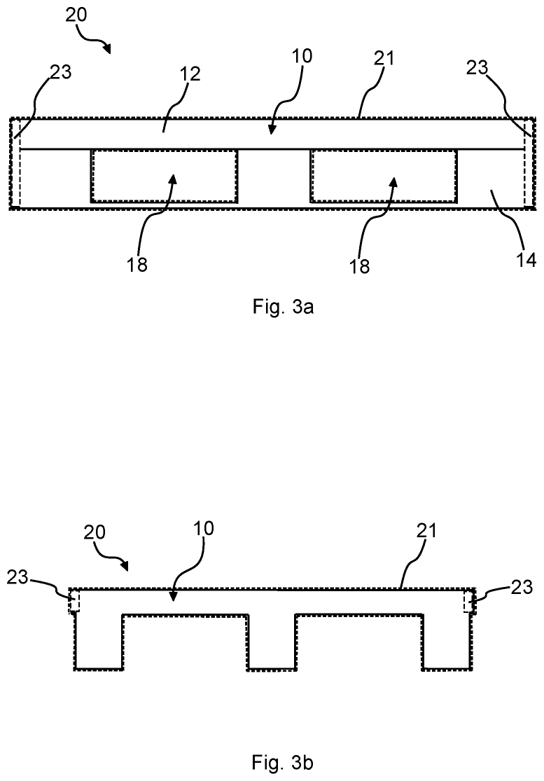

FIG. 3a illustrates the location of the exemplary cover elements of the paper-based pallet according to the invention on the outer cut edges of the paper pallet body in the view of FIG. 1a;

FIG. 3b illustrates the location of the exemplary cover elements of the paper-based pallet according to the invention on the outer cut edges of the paper pallet body in the view of FIG. 1b;

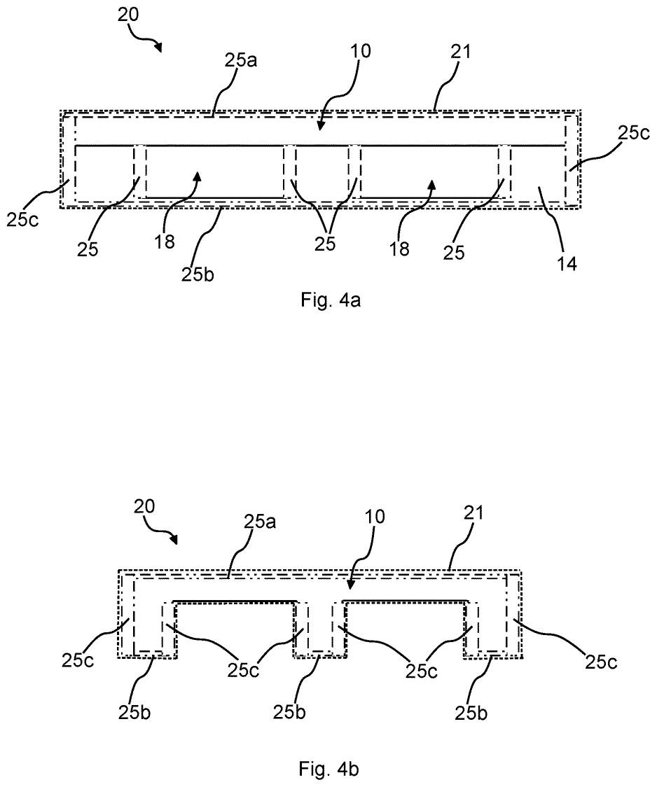

FIG. 4a illustrates the preferred location of the layers of the paper-based pallet according to the invention containing fibrous reinforcing material on the outer surface of the paper pallet body in the view of FIG. 1a;

FIG. 4b illustrates the preferred location of the layers of the paper-based pallet according to the invention containing fibrous reinforcing material on the outer surface of the paper pallet body in the view of FIG. 1b.

FIG. 1 shows a perspective view of an exemplary state-of-the-art paper pallet body 10, which in this case is the paper pallet disclosed in Hungarian patent application HU1700062A2. Additional views of this paper pallet can be found in the publication document of HU1700062A2.

In order to make it easier to distinguish between the paper pallet according to the invention and the paper pallet used as the starting paper pallet, the starting paper pallet is referred to as the paper pallet body.

A paper-based pallet according to the invention can be produced starting from any paper pallet body, not only from the paper pallet body 10 shown as an example in FIG. 1.

The paper pallet body 10 comprises a paper panel 12 with a load-bearing upper side 11 and paper legs 14 connected to it. It is noted that the panel 12 and the legs 14 can also be formed as a single element (integrally), which is common for example in the case of pressed paper pallets, but according to the function performed, a distinction may be made between the panel 10 with the load-bearing upper side 11 and the legs 14 connected thereto.

In the present embodiment, three rectangular legs 14 run parallel to the longest side of the panel 12 (which is also the longest side of the paper pallet body 10). The legs 14 have a base plate 15 and a side wall 17, in which two through openings 18 are formed. The forks of a forklift truck can be guided through the through openings 18 in order to move the paper pallet body 10. The panel 12 has covering flaps 12a on the longer side and covering flaps 12b on the shorter side, which are folded over and glued to the legs 14. The covering flaps 12a, 12b are delimited by cut edges 13, which define a portion of the outer surface of the paper pallet body 10.

The paper pallet body 10 according to FIG. 1 is shown schematically in FIGS. 1a and 1b in side views from the longer side and shorter side, respectively. FIGS. 2a and 2b show a paper-based pallet 20 according to the invention in the view corresponding to FIGS. 1a and 2b, where the starting point was the paper pallet body 10 according to FIG. 1. In the pallet 20 according to the invention, there is a 1-8 mm thick sprayed PU coating 21 formed from a sprayable PU system surrounding the entire outer surface of the paper pallet body 10, the contours of which are shown schematically with dotted lines in FIGS. 2a and 2b. In FIG. 2a and FIG. 2b, the PU coating 21 covers the entire surface within the contours indicated by the dotted line (except for the through openings 18). The outer surface of the paper pallet body 10 is any surface that is in contact with the external environment, so the PU coating 21 also covers the inner side walls 17 of the legs 14 and the surfaces delimiting the through openings 18, as well as the sides not shown in the figure.

Several types of sprayable PU systems are known, which are both suitable for creating the PU coating 21 according to the invention. Examples of such sprayable PU systems are:
Sprayable solvent-free polyurethane systems, including for example:
   Sprayable solvent-free TDI (toluene diisocyanate) or MDI (methylene diphenyl diisocyanate) polyurethane systems (composition: isocyanate+polyol)
Sprayable polyurea systems (composition: isocyanate+amine), including e.g.:
   Sprayable TDI (toluene diisocyanate) or MDI (methylene diphenyl diisocyanate) polyurea systems (composition: isocyanate+amine)
Sprayable hybrid polyurea systems (composition: isocyanate+polyol+amine), including e.g.:
   Sprayable TDI (toluene diisocyanate) or MDI (methylene diphenyl diisocyanate) hybrid polyurea systems (composition: isocyanate+polyol+amine)

The sprayable PU systems according to the invention are two-component systems and are solvent-free. There are also sprayable polyurethane systems which contain solvent, but the inventors found that the solvent in the sprayable polyurethane system containing solvent (typically in the amount of 30-40 weight %) “migrates” into (gets into) the structure of the paper after spraying and weakens the strength of the adhesives there, as well as the structural integrity of the paper through wetting. Moreover, even after drying, the solvent does not completely disappear from the coating and the structure of the paper, which also adversely affects the paper structure and the joint load-bearing capacity of the paper and the coating.

This effect does not occur with solvent-free PU systems, therefore the load-bearing capacity of paper-based pallets coated with solvent-free PU systems will be significantly better.

We note here that the polyurea systems and hybrid polyurea systems according to the invention are also solvent-free. Polyurea systems consist of an isocyanate+amine complex and are solvent-free. In the case of hybrid polyurea systems (isocyanate+amine complex+polyol), alcohol (polyol-multiple types and/or multiple alcohols) cannot be considered a solvent (despite the fact that in many cases alcohol is used as a solvent), since here the polyol is a natural part of the system, in terms of its function it is a chain forming material and not a solvent. The hybrid polyurea systems are also solvent-free.

Solvent-free polyurethane systems, polyurea and hybrid polyurea systems are, by their very nature, systems with a fast setting time (short pot life/open-time), having a setting time of typically less than 60 sec, in average 10-30 sec. To create the PU coating 21 according to the invention, a sprayable PU system with a setting time of 10-30 seconds is preferably used.

The PU coating 21 is produced by spraying the sprayable PU system on the outer surface of the paper pallet body 10 using a suitable high pressure, heated spraying machine. Spraying is preferably performed at a pressure of 140-250 Bar, preferably 160-210 Bar with a spraying apparatus heated to 40-90° C., preferably 60-80° C. The technology of spraying PU systems is well known (see, for example: Szycher'S handbook of Polyurethanes, Second edition, Michael Szycher, Ph.D., CRC Press, 2013) and for this purpose many types of spraying machines are commercially available. Suitable sprayers include those from the manufacturer GRACO, such as the Reactor E-XP2 (which is a high-pressure, heated sprayer with a spray head optimized for elastomer systems). Such spraying apparatus delivers the two components that make up the PU system, heated, separately (separated from each other) to the spray head, where they are mixed as a result of the high-pressure spraying, and the chemical reactions start which create the bonds that solidify the PU system in an extremely short time (less than 60 sec, typically 10-30 sec).

The thickness of the resulting PU coating 21 can be controlled in a known manner by adjusting the spraying flow, the spraying distance and the spraying pattern, and by repeating the spraying process, which allows to build up a PU coating 21 of the desired thickness from several sprayed layers.

If the material of the paper pallet body 10 is multi-layered cardboard with a hollow structure, which has cut edges 13 forming the outer surface of the paper pallet body 10, then in order to ensure adequate waterproofing, it is preferable to cover the cut edges 13 with a cover element 23 before forming the PU coating 21, as illustrated in FIGS. 3a and 3b, and to spray the sprayable PU system on the outer surface of the covering element 23 using the spraying machine, so that the coating 21 is placed on the covering element 23 at the cut edges 13. If no cover element 23 is used, the sprayed PU system may be sprayed into the inner cavities of the multi-layered cardboard at the cut edge, and either a very large amount of PU has to be sprayed on the cut edge 13 to fill the inner cavity structure, which makes the production more expensive, or the sprayed PU system does not form a solid waterproof surface.

It is noted that the cut edges 13 may be elsewhere, for example along the facing edges of the through openings 18, which are not visible in the two side views. All cut edges 13 are covered with the covering elements 23, which would prevent or complicate the waterproofing of the PU coating 21.

Anything that can seal the gaps leading into the hollow interior of the cardboard can be used as the covering element 23. The covering element 23 can be, for example, paper itself, which is glued to the cut edge 13, or it can be, for example, self-adhesive tape, etc. In a preferred embodiment the covering element 23 is a layer containing a fibrous reinforcing material, for example architectural facade mesh, plastic mesh, glass mesh, glass fabric, glass fibre, metallic wool, steel cord, carbon fibre reinforcing material, carbon fibre, hemp fibre, cut glass fibre reinforcing material. When using a layer containing a fibrous reinforcing material as a covering element 23, care should be taken to ensure that the fibrous reinforcing material preferably has perforations with a diameter of no more than 5 mm, because in the case of excessively large perforations, the covering element 23 does not perform its function, it does not properly cover the gaps in the internal hollow structure of the paper material.

If the material of the paper pallet body 10 is a pressed paper sheet, which is not hollow, then the cut edges 13 forming the outer surface do not require edge covering for the watertightness of the PU coating 21, but it can also be beneficial in order to increase the load-bearing capacity.

In addition to the cut edges 13 with a hollow structure, there may be other openings on the commercially available paper pallet bodies 10 that lead to internal cavities or grooves, the surface of which cannot be properly coated with spraying technology through the opening. It is also desirable to cover such openings with a cover element 23 of suitable size prior to spraying the PU system. The openings 18 for the forks of the forklift truck are not included here, since they are large enough to allow the surfaces bordering the openings 18 to be sprayed. Of course, if there are additional openings on these boundary surfaces that lead into cavities that are not accessible to the sprayer, these additional openings must also be covered with a suitable covering element 23.

FIGS. 4a and 4b illustrate an embodiment in which, in order to increase the static and dynamic load-bearing capacity, the parts of the paper pallet body 10 exposed to greater stress (e.g. on the load-bearing upper side 11 of the panel 12, on the lower side of the base plate 15, along the legs 14, especially along curved edges and glued joints) layers 25a, 25b, 25c containing fibrous reinforcing material are used for reinforcement, and the sprayable PU system is sprayed on their outer surface, so that the PU coating 21 not only surrounds the outer surface of the paper pallet body 10, but also the layers 25a, 25b, 25c containing the fibrous reinforcing material.

In addition to the reinforcement locations mentioned as examples, layers 25a, 25b, 25c containing fibrous reinforcing material may be used elsewhere, but it is also possible to use only one or the other of the layers 25a, 25b, 25c shown. The location of the reinforcement should be chosen according to the desired application.

The fibrous reinforcing material is preferably in this case also architectural facade mesh, plastic mesh, glass mesh, glass fabric, glass fibre, carbon fibre reinforcing material, or cut-glass fibre reinforcing material.

The layer 25a, 25b, 25c containing the fibrous reinforcing material can also serve as the covering element 23, provided that the perforations are small enough to form a continuous PU coating 21 as a result of spraying on the outer surface of the layer 25a, 25b, 25c. Of course, the use of the layer 25a, 25b, 25c containing the fibrous reinforcing material and the covering element 23 can also be combined, in which case no attention is required to the size of the perforations of the layer 25a, 25b, 25c containing the fibrous reinforcing material, since underneath there is the covering element 23 or the outer surface of the paper pallet body 10 itself, so overall a solid, continuous PU coating 21 is created by spraying.

An alternative way of using fibrous reinforcing material is to add the fibrous reinforcing material to the sprayable PU system during the spraying process. This was technically achieved by introducing a flow of fibrous reinforcing material into the spray flow of the sprayable PU system Suitable spraying machines are commercially available, for example FRP Chop system of GRACO Inc. is such a cut fibre spraying/feeding apparatus. The fibrous reinforcing material mixed into the sprayable PU system can be combined with the previously presented technologies, so for example by using the covering element 23 and/or layers 25a, 25b, 25c containing the fibrous reinforcing material, whereby a pallet 20 with an even higher load capacity is obtained.

In order to determine the properties of the pallet 20 according to the invention, several experiments were carried out in two test phases.

### First Test Phase

In the first test phase, as a first step, the inventors examined whether the PU coating 21 can be properly applied to a paper surface and whether it adheres properly. In order to do this, several PU coatings of different qualities were developed on cardboard, the latter being referred to as paper sheet in the following. The PU systems used were solvent-free TDI/MDI polyurethane systems, pure polyurea systems and hybrid polyurea systems.

Firstly, it was found that PU systems have excellent adhesion to paper without any surface preparation. The two layers “fuse” together.

The inventors then tested the water resistance of the PU coated paper sheet. The prepared PU coated and uncoated paper sheets were placed in a sealable plastic container of about 0.125 m3, then a commercially available vaporizer was placed next to them, and a humidity of around 90% was created in the test space, where the coated and uncoated paper sheets spent 24 hours under the described conditions. The effect of water vapour was investigated using both subjective and objective methods.

Within the framework of the subjective test, the inventors examined the perceptible properties (touch/texture/strength) of the PU-coated paper sheet taken out of the vapour chamber in comparison with paper sheets without PU coating. It was found that while the uncoated paper sheet became wet and wavy and also softened, no changes were found on the PU coated paper sheet compared to the condition before the vapour chamber.

In the objective study, the tensile strength of PU coated and uncoated paper sheets coming from the vapour chamber was compared with their tensile strength measured before the vapour chamber. It was found that the tensile strength of PU coated paper sheets before treatment in the vapour chamber increased by a factor of approximately 7 compared to uncoated paper sheets. After the vapour chamber, the tensile strength of the uncoated paper plate decreased to almost zero, while the tensile strength of the PU coated paper plate did not change after 24 hours spent in the vapour chamber.

Overall, it was found that all types of PU coatings tested provided virtually 100% protection of paper surfaces against moisture in the moisture chamber, while uncoated paper sheets were unsuitable for use as paper pallets.

The PU coated paper sheets were then subjected to further mechanical tests.

In this context, the abrasion resistance was tested and it was found that the PU coated paper sheets practically delivered the abrasion resistance properties expected from PU coatings.

Since for paper pallets the protection against surface rupture would be particularly important, the inventors performed a drop-ball test on coated and uncoated paper sheets before and after the vapour chamber to test this. To measure the relative tolerance of point-like load, the inventors loaded the experimental paper plates with a test specimen weighing 1 kg and having a base size of 1 cm2, statically and then dynamically, by dropping the test specimen onto the surface from a height of 1 m. After repeating the test 50 times, the inventors looked at what percentage of cases resulted in permanent deformity or rupture. The results are summarized in the following two tables:

TABLE 1

| Title | Rupture - Static load |
|---|---|
| Uncoated dry paper sheet | Permanent deformation ~10%/ |
| | Rupture 30% |
| Uncoated paper sheet, after the | Rupture 100% |
| vapour chamber | |
| PU coated paper sheet | Permanent deformation 0%/ |
| | Rupture 0% |
| PU coated paper sheet, after the | Permanent deformation <5%/ |
| vapour chamber | Rupture <10% |

Table 1 clearly shows that the PU coating significantly increased the protection against permanent deformation and rupture caused by point-like static loads. It can be considered a significant result that, while the tested uncoated paper sheets either suffered permanent deformation or ruptures under static point-like loading in a total of 40% of the cases, no such deformation or ruptures were observed at all for the PU-coated paper sheets. It should also be noted that the uncoated paper sheet penetrated 100% due to moisture, while this value dropped below 10% when PU coatings were applied.

TABLE 2

| | Rupture - Dynamic drop from |
|---|---|
| Title | a height of 1 m |
| Uncoated dry paper sheet | Permanent deformation ~30%/ |
| | Rupture 70% |
| Uncoated paper sheet, after the | Rupture 100% |
| vapour chamber | |
| PU coated paper sheet | Permanent deformation 10%/ |
| | Rupture 10% |
| PU coated paper sheet, after the | Permanent deformation 10%/ |
| vapour chamber | Rupture 10% |

The results of the test series with dynamic drop, summarised in Table 2, show even more significant results. Even in dry condition, the untreated paper sheet still penetrated in 70% of the measurements, while the PU coated paper sheet showed a rupture rate of less than 10%. In addition, the resistance of the PU coated paper sheets to rupture did not change when exposed to the vapour chamber.

From the above, it can be concluded that the life cycle of conventional paper sheets can be significantly extended by applying PU coating even when the paper sheet is used in a humidity protected place. In a highly humid and moist environment, PU coating is essential to ensure adequate mechanical protection.

### Second Test Phase

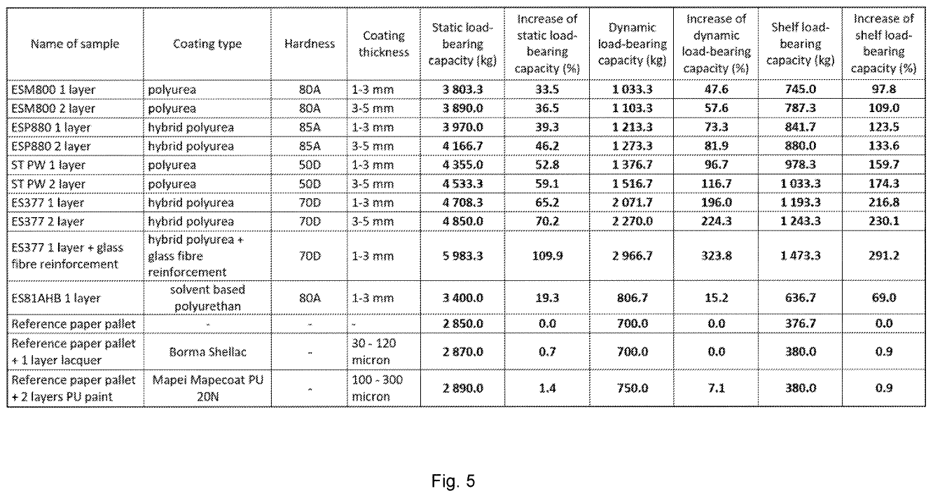

After that, in the second test phase, pallets 20 with PU coating 21 according to the invention obtained by spraying were tested. In this second test phase, the inventors coated commercially available 5-layer paper pallets with different PU coatings 21, in different ways: with and without reinforcement, and in different layer thicknesses: single layer having 1-3 mm thickness and double layer having 3-5 mm thickness). The resulting paper-based pallets 20 provided with PU coating 21 were tested under industrial conditions, and comparative tests were performed with the starting paper pallets without coating and with various other types of coating. Other coatings tested were: solvent-based polyurethane coating, varnish coating, polyurethane paint coating. The test results are presented in FIG. 5.

The paper based pallets according to the invention were spray-coated in various thicknesses with various polyurea and hybrid polyurea systems of ERA Polymers, and further for the sake of comparison, with a solvent-based polyurethane system which is commercially available under the name ERASPRAY ES81A HB system, with Borma Shellac-type lacquer and with solvent-based polyurethane paint. Due to spray unevenness, the thickness of the PU coating 21 varied between 1 and 3 mm in case of a single layer, so the average thickness of the PU coating 21 was about 2 mm, and the thickness of the PU coating 21 varied between 3 and 5 mm in double layers, so the average thickness was 4 mm. The series of experiments were performed with polyurea and hybrid polyurea systems of various hardnesses.

During the tests, standard EUR pallet size paper pallets made of 5 layers of cardboard were used. These pallets were coated with various polyurea and hybrid polyurea materials using high-pressure heated spraying apparatus.

The load capacity of the coated pallets were examined: static load capacity, dynamic load capacity and shelf load capacity.
Static load-bearing capacity test: the maximum load capacity of the pallets were tested with standard measuring equipment while the pallets were standing on a flat surface, and the maximum load was measured at which the pallets did not suffer permanent deformation.
Dynamic load-bearing capacity test: the load on the pallets was increased on a shaking bench and the maximum load was measured at which the tested pallet did not suffer permanent deformation.
Shelf load-bearing capacity test: the test was the same as for the static load test, but in this case the pallets stood on a metal frame corresponding to a “typical” shelf system, i.e. they were not supported in the middle.

In the comparative tests, the solvent-based polyurethane was also applied in a single layer (1-3 mm thickness), and the other two comparative coatings were applied in the usual way, the varnish in one layer thickness (30-120 microns) and the polyurethane paint in two layers thickness (100-300 microns). The three types of tests described above were performed in this way on both coated pallets and reference uncoated pallets.

For the series of experiments, pallets 20 were also produced in which the 5-layer paper pallet served as the starting point, and cut glass fibre was added to the PU coating 21 during spraying, thus obtaining a PU coating 21 containing glass fibre reinforcement.

After that, the behaviour of the initial 5-layer paper pallets, the pallets according to the invention 20 formed therefrom, and the pallets with other coatings created as a comparison were examined under operating conditions.

With the paper-PU hybrid system, the static, dynamic and shelf load-bearing capacity of the tested paper pallets has increased to such an extent that the pallets are now suitable for any general transport and storage task.

Using the single-layer PU coating 21 according to the invention, the static load-bearing capacity increased by 33-65% compared to the original paper pallets, which was increased by up to 15% with the application of the second layer. There was an even more significant improvement in the dynamic load-bearing capacity. With the application of just one layer, the dynamic load-bearing capacity increased by 47-116%, and the second layer resulted in an additional 10-20% increase. The greatest improvement occurred in the shelf load-bearing capacity: applying just one layer of PU coating provided an increase in the shelf load-bearing capacity of more than 97%, and with two layers we even experienced an increase of 230%. The glass fibre reinforcement greatly increased each type of load-bearing capacity, even with the application of a single layer of PU coating, the inventors measured an improvement of 109% for the static load-bearing capacity, an improvement of 323% for the dynamic load-bearing capacity and an improvement of 291% for the shelf load-bearing capacity.

On the other hand, it is clear from the comparative measurements that the lacquer layer and the two layers of traditional polyurethane paint hardly resulted in any improvement. The lacquer layer did not increase the measured load-bearing capacities by even 1%, in case of the polyurethane paint the static load-bearing capacity and shelf load-bearing capacity increased by around 1%, and even the dynamic load-bearing capacity only increased by 7%.

The coating created from the two-component solvent based polyurethane system also significantly lagged behind the polyurea and hybrid polyurea coatings of the same thickness. Here, the static load-bearing capacity increase was 19%, the dynamic load-bearing capacity increase was 15%, and the shelf load-bearing capacity was 69%. The significant difference is largely due to the unfavourable effect of the solvent as described above.

In all cases, care was taken to test several times and for longer periods of time during each phase.

### SUMMARY OF RESULTS

The PU coating 21 according to the invention provided sufficient protection of the paper sheets against moisture. The inventors found that the water resistance/moisture resistance of pallets 20 with PU coating 21 (in case of a damage-free coating) can be up to 100%.

The inventors observed a noticeable improvement in the load-bearing capacity of the paper sheets. As a result of the tests, it was found that with the inventive coating systems, even without fibre reinforcement, the inventors achieved a 33-70% increase in the static load-bearing capacity of the tested pallets and a 47-224% increase in the dynamic load-bearing capacity and a 97-230% increase in the shelf load-bearing capacity, and the inventors minimized the possibility of mechanical damage to the pallets, thereby increasing the expected lifetime and the number of cycles spent in use.

Overall, it can be concluded that the PU coating 21 formed by spraying increased the load-bearing capacity of the initial paper pallet bodies 10 in an unexpected way even at a layer thickness of a few mm, which could be further increased by using fibrous reinforcing material, while the weight of the pallet 20 did not increase significantly. The pallet 20 also became waterproof and its flammability was significantly reduced due to the continuous PU coating 21 that completely surrounded the outer surface of the paper pallet body 10. The production costs have increased only moderately, which is easily compensated by the increased cycle time of the pallet 20 and its wider applicability due to its higher load-bearing capacity.

Various modifications to the above disclosed embodiments will be apparent to a person skilled in the art without departing from the scope of protection determined by the attached claims.

The invention claimed is:

1. A waterproof paper-based pallet having a paper pallet body, the paper pallet body comprising a paper panel having a load-bearing upper side and paper legs connected to the paper panel, characterised in that the paper pallet body has a spray-formed coating of a sprayable synthetic polymer system on its entire outer surface, wherein the synthetic polymer system is selected from the group consisting of a solvent-free polyurethane system, a polyurea system, and a hybrid polyurea system, and wherein the coating thickness is 1 to 8 mm.

2. The waterproof paper-based pallet according to claim 1, characterized in that the paper pallet body is a multi-layered cardboard material with a hollow structure, wherein the cut edges of said cardboard material forming an outer surface of the paper pallet body are covered with an edge covering element, and wherein the edge covering element is provided with said spray-formed coating.

3. The waterproof paper-based pallet according to claim 2, characterized in that the covering element is a layer of fibrous reinforcing material having perforations of a diameter of up to 5 mm.

4. The waterproof paper-based pallet according to claim 1, characterized in that the paper pallet body is made of a pressed paper sheet or multilayer cardboard.

5. The waterproof paper-based pallet according to claim 1, characterized in that a fibrous reinforcing layer is arranged at least partially on the upper side of the paper panel and/or legs and/or curved edges and/or glued joints of the paper pallet body, and the fibrous reinforcing layer is covered with said spray-formed coating.

6. The waterproof paper-based pallet according to claim 3, characterized in that the fibrous reinforcing material is selected from the group consisting of architectural facade mesh, plastic mesh, glass mesh, glass fabric, glass fibre, metallic wool, steel cord, carbon fibre reinforcing material, carbon fibre, hemp fibre, and cut-glass fibre reinforcing material.

7. The waterproof paper-based pallet according to claim 1, characterized in that the sprayable synthetic polymer system contains a fibrous reinforcing material.

8. The waterproof paper-based pallet according to claim 1, characterized in that the coating thickness is 1 to 5 mm.

9. A method of producing a waterproof paper-based pallet having a paper pallet body, the paper pallet body comprising a paper panel having a load-bearing upper side and paper legs connected to the paper panel, characterised by creating a polymeric coating having a thickness of 1 to 8 mm on entire outer surface of the paper pallet body by spraying onto said paper pallet body a sprayable synthetic polymer system selected from the group consisting of a solvent-free polyurethane system, a polyurea system, and a hybrid polyurea system.

10. The method according to claim 9, characterised in that the paper pallet body is a hollow-structured multi-layered cardboard material having cut edges which form an outer surface of the paper pallet body covered with an edge covering element and wherein the sprayable synthetic polymer system is applied onto an outer surface of the edge covering element.

11. The method according to claim 10, characterized in that the covering element is a layer of fibrous reinforcing material having perforations of a diameter of up to 5 mm.

12. The method according to claim 9, characterized in that the paper pallet body is made of a pressed paper sheet or multilayer cardboard.

13. The method according to claim 9, characterized by arranging a layer comprising a fibrous reinforcing material at least partially on the upper side of the paper panel and/or legs and/or curved edges and/or glued joints of the paper pallet body, and spraying the sprayable synthetic polymer system onto an outer surface of the layer comprising the fibrous reinforcing material.

14. The method according to claim 11, characterized in that the fibrous reinforcing material is selected from the group consisting of architectural facade mesh, plastic mesh, glass mesh, glass fabric, glass fibre, metallic wool, steel cord, carbon fibre reinforcing material, carbon fibre, hemp fibre, and cut-glass fibre reinforcing material.

15. The method according to claim 9, characterized by adding a fibrous reinforcing material, preferably cut-glass fibre, to a spray flow of the synthetic polymer system during the spraying of the synthetic polymer system.

16. The method according to claim 9, characterized in that said polymeric coating thickness is 1 to 5 mm.

17. The method according to claim 9, characterized in that the sprayable synthetic polymer system is sprayed at a pressure of 140-250 Bar.

18. The method according to claim 17, characterized in that the sprayable synthetic polymer system is sprayed with a spraying apparatus heated to a temperature of 40-90° C.

19. A waterproof paper-based pallet having a paper pallet body, the paper pallet body including a paper panel with a load-bearing upper side and paper feet connected to the paper panel, characterized in that said pallet is created by a method according to claim 9.

20. A waterproof paper-based pallet with a polymeric coating having a thickness in the range of about 1 mm to about 8 mm, said polymeric coating being the reaction product of a solvent-free isocyanate composition and a resin which is a member of the group consisting of an amine-terminated resin, a hydroxy-terminated resin, and mixtures thereof.
